(19) United States
(12) Patent Application Publication
(10) Pub. No.: US 2009/0122194 A1
(43) Pub. Date: May 14, 2009

(54) METHOD AND APPARATUS FOR REDUCING PICTURE

(75) Inventors: Sung-Uk Jung, Seoul (KR); Yun-Su Chung, Daejeon (KR); Ki-Young Moon, Daejeon (KR); Kyo-II Chung, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institute, Daejeon (KR)

(21) Appl. No.: 12/143,332

(22) Filed: Jun. 20, 2008

(30) Foreign Application Priority Data
Nov. 9, 2007 (KR) 10-2007-0114490

(51) Int. Cl. H04N 9/74

(52) U.S. Cl. 348/581; 348/E09.055

(57) ABSTRACT

Provided are a method and apparatus for reducing picture, which can obtain a reduced picture by previously creating a picture reduction map that stores effective-pixel locations selected according to a picture reduction scale and a picture reduction algorithm, and then matching an input picture with the picture reduction map. The method for reducing picture includes constructing a picture reduction map according to a size of an incoming picture, and generating a sub-picture for reduction of an input picture by using the picture reduction map.

### CROSS-REFERENCE TO RELATED APPLICATIONS

This application claims priority under 35 U.S.C. §119 to Korean Patent Application No. 10-2007-0114490, filed on Nov. 9, 2007, the disclosure of which is incorporated herein by reference in its entirety.

### BACKGROUND OF THE INVENTION

1. Field of the Invention

The present disclosure relates to a picture reducing technique, and more particularly, to a method and apparatus for reducing picture, which can obtain a reduced picture by previously creating a picture reduction map that stores effective-pixel locations selected according to a picture reduction scale and a picture reduction algorithm, and then matching an input picture with the picture reduction map.

This work was supported by the IT R&D program of MIC/IITA[Work management number: 2007-S-020-01, Work title: Development Of The Bio Recognition System To Protect Privacy]

2. Description of the Related Art

As picture display devices are generalized, picture conversion techniques are being increasingly developed. Portable devices are being widely used, and thus a picture reduction technique is considered very important for picture expression and transmission in the portable devices.

A related art picture reduction technique has been mainly focused on reducing a picture for televisions or personal computers (PC).

Examples of the picture reduction technique may include picture reduction using discrete cosine transform (DCT) and inverse discrete cosine transform (IDCT), and picture extraction by controlling sampling time by hardware.

Those techniques are being widely used because they can contribute to good picture quality. In most cases, such logic is used in a device implemented in hardware. However, the picture reduction techniques have limitations in that many computing operations are required and they must be implemented in hardware. In actuality, if an algorithm of the above techniques is implemented in software in an embedded system not on a PC, it is impossible to process picture reduction at a high speed.

Also, those techniques are used in the case of picture media such as TVs or plasma display panels (PDP), and thus consider picture quality most important. However, in the field of picture recognition including face recognition or object recognition, main concerns are picture reduction based on a main pattern of an object and a high speed of picture processing, not the picture quality.

Thus, the related art picture reduction method has a limitation in that a picture reduction process for object recognition cannot be implemented in a small device that has a relatively slow processing speed, such as an embedded system.

### SUMMARY

Therefore, an object of the present invention is to provide a method and apparatus for reducing picture capable of constructing a picture reduction map from a predefined picture reduction scale, and quickly reducing an input picture by using the picture reduction map.

Another object of the present invention is to provide a method and apparatus for reducing picture capable of reducing picture by performing sub-sampling using a picture reduction map and performing interpolation using sub-pictures obtained through the sub-sampling.

To achieve these and other advantages and in accordance with the purpose(s) of the present invention as embodied and broadly described herein, a method for reducing picture in accordance with an aspect of the present invention includes: constructing a picture reduction map according to a size of an incoming picture; and generating a sub-picture for reduction of an input picture by using the picture reduction map.

To achieve these and other advantages and in accordance with the purpose(s) of the present invention, an apparatus for reducing picture in accordance with another aspect of the present invention includes: a picture reduction map generator for generating a picture reduction map according to a size of an incoming picture; and a sub-picture generator for generating a sub-picture for reduction of an input picture by using the picture reduction map.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram of an apparatus for reducing picture according to an embodiment of the present invention;

FIG. 2 is a block diagram of a picture reduction map generator according to the embodiment of the present invention;

FIG. 3 is a block diagram of a sub-picture generator according to the embodiment of the present invention;

FIG. 4 is a flowchart of a method for reducing picture according to an embodiment of the present invention;

FIG. 5 is a flowchart of a picture reduction map constructing method according to the embodiment of the present invention;

FIG. 6 is a flowchart of a sub-picture extracting method according to the embodiment of the present invention; and

FIGS. 7A through 7E illustrate an example of a picture reducing process according to the embodiment of the present invention.

### DETAILED DESCRIPTION OF EMBODIMENTS

A method and apparatus for reducing picture according to embodiments of the present invention is characterized in that a picture reduction map is constructed in advance according to a reduction scale, sub-sampling is performed on a picture according to an interpolation method to be used by using the picture reduction map in receiving a picture stream, and then interpolation is performed using sub-pictures obtained by the sub-sampling, thereby reducing the picture. According to the embodiments of the present invention, the picture reduction can be performed by designating locations of pixels to be sampled in a picture reduction map in advance, and matching an input picture with the picture reduction map in real-time.

Hereinafter, specific embodiments will be described in detail with reference to the accompanying drawings. The description will be mainly focused on parts that are needed to understand operations and effects of the embodiments of the present invention.

The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

A picture reduction technique according to embodiments of the present invention will now be described with reference to accompanying drawings.

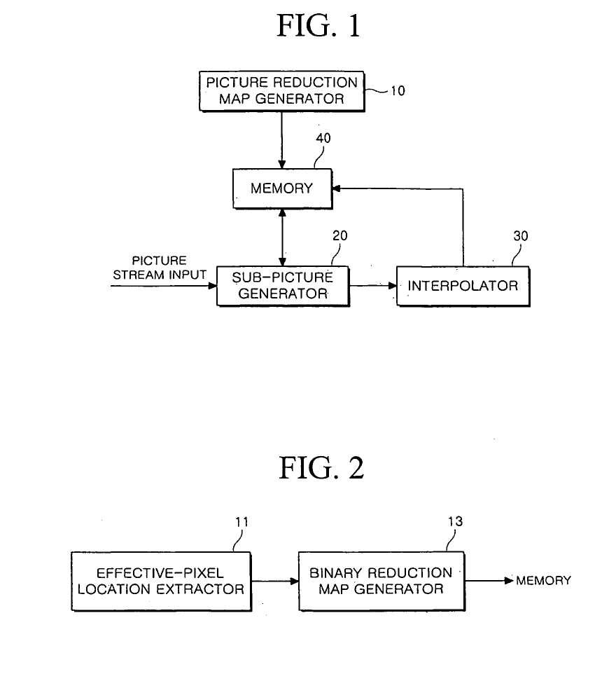

FIG. 1 is a block diagram of an apparatus for reducing picture according to an embodiment of the present invention.

The apparatus for reducing picture includes a picture reduction map generator 10, a sub-picture generator 20, and interpolator 30, and a memory 40.

The picture reduction map generator 10 constructs a picture reduction map according to a size of an incoming picture. If a size of the incoming picture or a reduction scale is predetermined in an offline mode, the picture reduction map generator 10 constructs a picture reduction map by previously computing pixel locations of an incoming picture and an outgoing picture in the case of picture reduction employing a sub-sampling method. The picture reduction map refers to a map that defines pixels to be sampled in advance.

The sub-picture generator 20 compares an input picture with the picture reduction map, thereby sampling the picture. The sub-picture generator 20 generates a sub-picture by storing a pixel of the input picture corresponding to, a pixel value of, e.g., ‘1’ of the picture reduction map and not storing a pixel of the input picture corresponding to a pixel of, e.g., ‘0’ of the picture reduction map.

The interpolator 30 performs picture interpolation using generated sub-pictures. The interpolator 30 does not perform the interpolation for improved picture quality on one sub-picture, and performs the interpolation on a plurality of sub-pictures.

The memory 40 stores the sub-pictures and the picture reduction map.

FIG. 2 is a block diagram of the picture reduction map generator according to the embodiment of the present invention.

The picture reduction map generator 10 according to the embodiment of the present invention includes an effective-pixel location extractor 11, and a binary reduction map generator 13.

The effective-pixel location extractor 11 extracts locations of effective pixels of an incoming picture according to a reduction scale and a kind of interpolation method to be used.

The binary reduction map generator 13 generates a binary picture reduction map with respect to a picture of a specific size, which is generated by the effective-pixel location extractor 11.

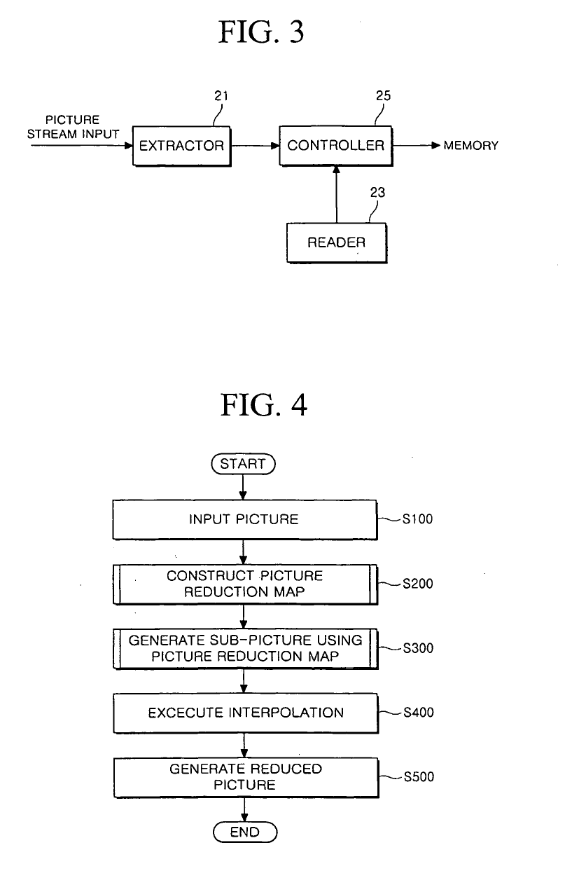

FIG. 3 is a block diagram of the sub-picture generator according to the embodiment of the present invention.

The sub-picture generator 20 according to the embodiment of the present invention includes an extractor 21, a reader 23, and a controller 25.

The extractor 21 extracts a pixel of a specific location from an incoming picture stream.

The reader 23 reads each pixel value of the picture reduction map stored in the memory 40.

The controller 25 determines presence of a pixel value in the picture reduction map. If a pixel value is present in the picture reduction map, the controller 25 stores, as a sub-picture, a pixel of the picture stream at a location corresponding to the pixel value of the picture reduction map. The interpolator 30 performs picture interpolation using a plurality of sub-pictures generated in the aforementioned manner. A picture obtained by the interpolator 30 is stored in the memory 40.

A picture reduction operation of the apparatus for reducing picture will now be described with reference to FIGS. 1 through 3. First, the picture reduction map generator 10 generates a picture reduction map in advance. Thereafter, the sub-picture generator 20 generates sub-pictures of an input picture stream by using the picture reduction map.

In detail, the picture reduction map generator 10 extracts locations of effective pixels of a picture according to a reduction scale and a kind of interpolation method through the effective-pixel location extractor 11, and then computes pixel locations of an incoming picture and an outgoing picture for picture reduction using a sub-sampling method to construct a picture reduction map with binary numbers converted from the location values. The binary reduction map generator 13 generates a binary picture reduction map of a picture of a specific size generated by the effective-pixel location extractor 11, and then primarily stores the picture reduction map in the memory 40.

Thereafter, the extractor 21 of the sub-picture generator 20 extracts a pixel of a specific location from an input picture stream, and outputs the extracted pixel value to the controller 25. The controller 25 determines presence of a pixel value of the picture reduction map corresponding to the specific location. The pixel value of the picture reduction map is stored in the memory 40 and read by the reader 23. If the pixel value corresponding to the specific location of the pixel is present in the picture reduction map, the controller 25 stores the corresponding pixel of the picture stream in the memory 40 as a sub-picture.

FIG. 4 is a flowchart of a method for reducing picture according to the embodiment of the present invention.

In operation S100, a picture stream is input. In operation S200, a picture reduction map is constructed if a picture size is known. In detail, if a picture size or a reduction scale is predetermined in an offline mode, pixel locations of an incoming picture and an outgoing picture in the case of picture reduction using sub-sampling are previously computed, and then the computed pixel location values are represented by binary numbers, thereby constructing the picture reduction map.

In detail, in sub-sampling, if a value of (x, y) coordinates of a picture is sampled, value ‘1’ is set in the picture reduction map. If not sampled, value ‘0’ is set in the picture reduction map. For interpolation, if a pixel corresponding to (x, y) coordinates is sampled, respective picture reduction maps for surrounding pixels are constructed. For example, if interpolation is performed using four pixels, picture reduction maps are respectively constructed with respect to (x−1, y), (x, y−1), (x+1, y) and (x, y+1) coordinates of a picture to be reduced.

Thereafter, the input picture is sampled by using the constructed picture reduction map. For example, for the input picture received in the form of a bitstream, a pixel of the input picture is stored if a pixel value of the picture reduction map corresponding to the pixel is ‘1’. If the pixel value of the picture reduction map is ‘0’, the corresponding pixel of the input picture is not stored.

This operation is performed on every pixel. In operation S300, if interpolation is performed, n sub-pictures are output with respect to n picture reduction maps

Thereafter, in operation S400, the interpolation is performed using the sub-pictures extracted by the picture reduction map. For example, if sub-pictures are obtained from four surrounding pixels, the mean value of the four values is computed. If there is just one picture reduction map, a picture obtained by using the picture reduction map is output as it is. In operation S500, a reduced picture is obtained.

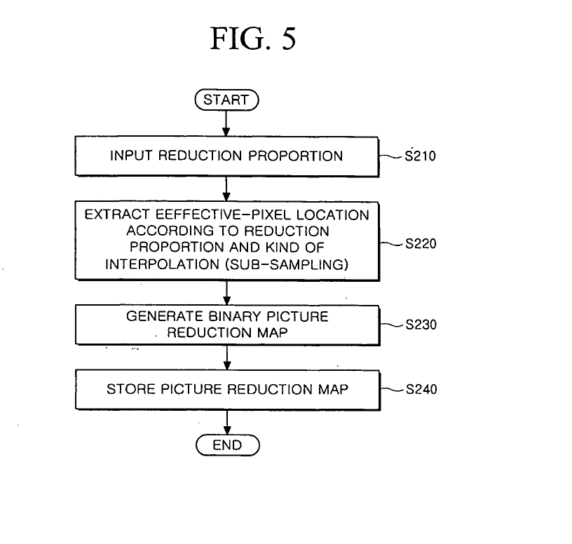

FIG. 5 is a flowchart illustrating a picture-reduction-map constructing method according to the embodiment of the present invention.

In operation S210, a reduction scale is input. In operation S220, locations of effective pixels of a picture are extracted according to the reduction scale and a kind of interpolation method to be used. The locations of the effective pixels are selected through sub-sampling according to the reduction scale. A location of a pixel to be sampled for picture reduction is indicated by ‘1’, and a location of a pixel that is not to be sampled is indicated by ‘0’.

Thus, in operation S230, if a picture with N×M size is input, a binary picture reduction map of N×M size is generated.

Thereafter, the binary reduction map is stored in operation S240. Herein, the number of bits optimized for one command varies according to a system. Thus, it is proper to represent data using 64 bits in the case of a 64-bit machine and to represent data using 32 bits in the case of a 32-bit machine.

For example, in the case of a 32 bit embedded system, the binary picture reduction map is stored in units of 32 bits.

For example, if the reduction map is represented by binary numbers of ‘1010101010101010101010101010101’, it is stored as a decimal number of ‘2863311530’.

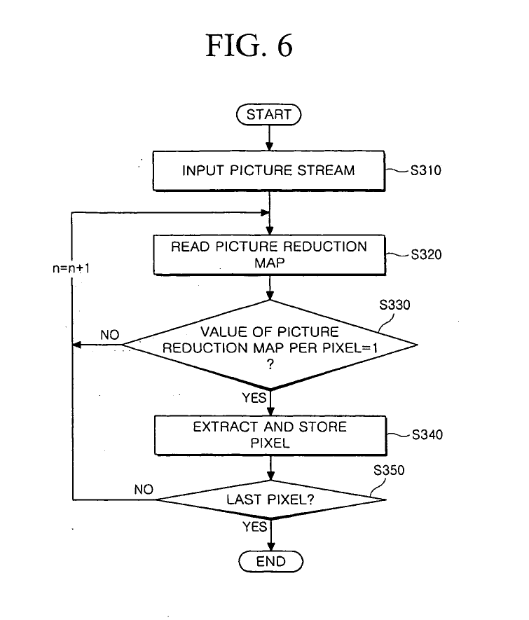

FIG. 6 is a flowchart illustrating a sub-picture extracting method according to the embodiment of the present invention.

In operation S310, a bitstream of a picture is input. In operation s320, a pixel value of the picture reduction map corresponding to each pixel location (x, y) of the picture is extracted.

In operation S330, it is determined whether an extracted value of the picture reduction map corresponding to the pixel location (x, y) is ‘1’.

If the value of the picture reduction map corresponding to the pixel location (x, y) is 1, the operation S340 is performed. If not, the operation returns to operation S320 to check the next pixel.

In operation S340, if the value of the picture reduction map corresponding to the pixel location (x, y) of the picture is ‘1’, a corresponding pixel of the picture at the location (x, y) is extracted and stored as a sub-picture.

In operation S350, it is checked whether the corresponding pixel is the last pixel of the input picture. If the corresponding pixel is the last pixel, the operation is completed.

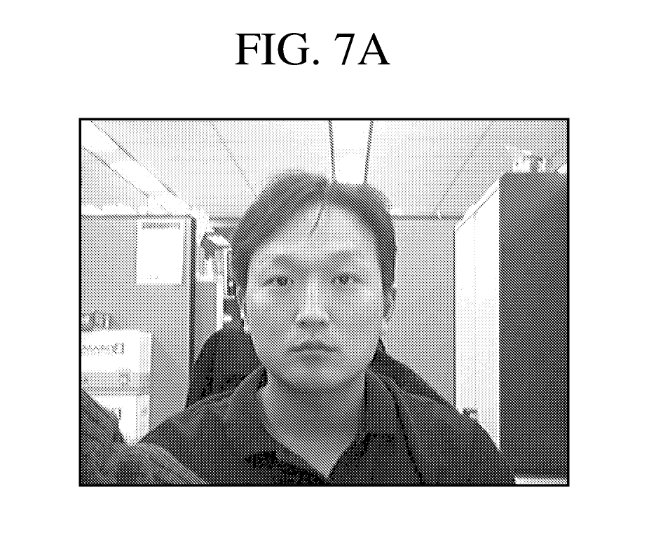

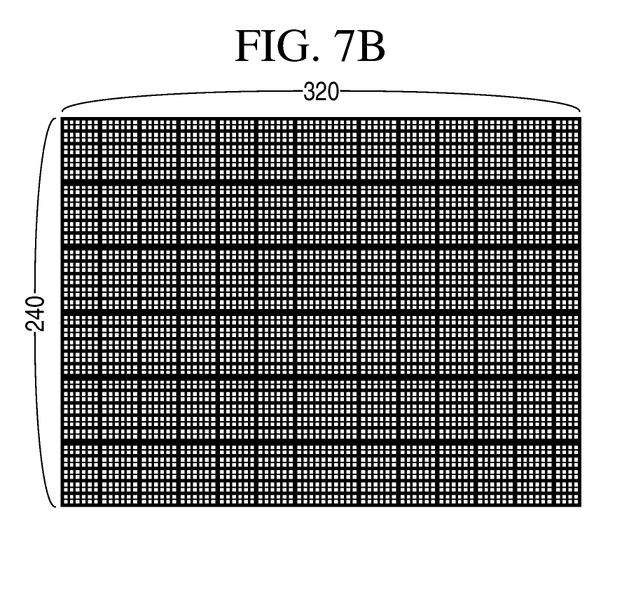

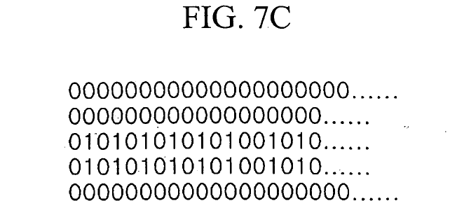

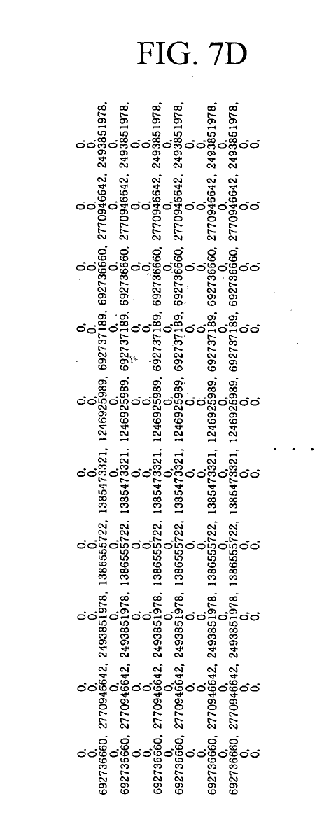

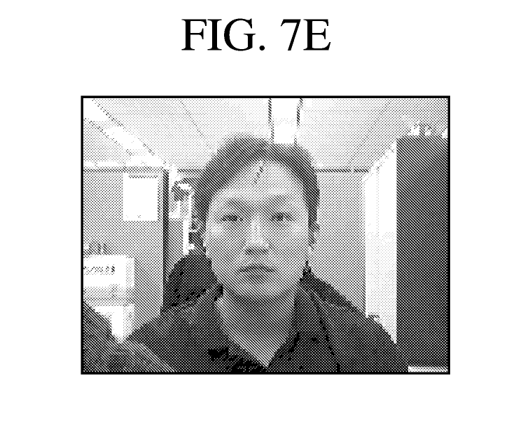

FIGS. 7A through 7E are views illustrating an example of a picture reduction process according to the embodiment of the present invention.

FIG. 7A illustrates an input picture, and FIG. 7B illustrates a binary picture reduction map. In FIG. 7B, white portions indicate locations of a picture on which a sampling is to be performed for picture reduction. The picture reduction map illustrated in FIG. 7B is merely an example of the embodiment of the present invention. If the interpolation is performed, the picture reduction map increases according to the number of pixels being used. FIG. 7C illustrates binary bits representing the picture reduction map, and FIG. 7D illustrates decimals representing the picture reduction map in units of 32 bits. Consequently, according to the embodiment of the present invention that uses the picture reduction map, a reduced picture as shown in FIG. 7E can be obtained.

In the method and apparatus for reducing picture according to the exemplary embodiments of the present invention, a picture reduction map is computed in advance to minimize compute quantity, and an input picture is reduced by using the picture reduction map, so that the complex computation is simplified and thus a picture can be reduced in real-time.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A method for reducing picture, the method comprising:
constructing a picture reduction map according to a size of an incoming picture; and
generating a sub-picture for reduction of an input picture by using the picture reduction map.

2. The method of claim 1, further comprising performing interpolation using a plurality of sub-pictures.

3. The method of claim 1, wherein the constructing of the picture reduction map comprises:
inputting a reduction scale;
extracting locations of effective pixels of a picture according to the reduction scale and an interpolation method being used;
generating a binary picture reduction map according to the extracted locations of the effective pixels; and
storing the picture reduction map.

4. The method of claim 1, wherein the generating of the sub-picture comprises:
extracting a pixel of a specific location from a bitstream of the input picture; and
determining whether a pixel value corresponding to the specific location is present in the picture reduction map, and storing the pixel of the specific location as a sub-picture on the basis of the determination result.

5. The method of claim 4, wherein the storing of the pixel of the specific location comprises:
storing the pixel of the specific location as a sub-picture if a pixel value corresponding to the specific location of the input picture is present in the picture reduction map;
skipping storage of the pixel of the specific location if a pixel value corresponding to the specific location is not present in the picture reduction map; and
repeating the preceding operations until the last pixel of the input picture.

6. An apparatus for reducing picture comprising:
a picture reduction map generator for generating a picture reduction map according to a size of an incoming picture; and
a sub-picture generator for generating a sub-picture for reduction of an input picture by using the picture reduction map.

7. The apparatus of claim 6, further comprising an interpolator for performing picture interpolation using a plurality of sub-pictures.

8. The apparatus of claim 6, further comprising a memory for storing the sub-picture and the picture reduction map.

9. The apparatus of claim 6, wherein the picture reduction map generator comprises:
an effective-pixel location extractor for extracting a location of an effective pixel according to a picture reduction scale and a kind of interpolation method to be used; and
a binary reduction map generator for generating a binary picture reduction map for a picture of a specific size generated by the effective-pixel location extractor.

10. The apparatus of claim 6, wherein the sub-picture generator comprises:
an extractor for extracting a pixel of a specific location from a bitstream of the input picture;
a reader for reading a pixel value of the picture reduction map; and
a controller for storing the pixel of the specific location as a sub-picture if a pixel value corresponding to the specific location of the pixel is present in the picture reduction map.

11. The apparatus of claim 10, further comprising an interpolator for performing picture interpolation using a plurality of sub-pictures generated by the controller.
